(19) United States
(12) Patent Application Publication
(10) Pub. No.: US 2024/0156095 A1
(43) Pub. Date: May 16, 2024

(54) ACARICIDE HETERODISSEMINATION BY SMALL MAMMALS

(71) Applicant: BanfieldBio Inc., Woodinville, WA (US)

(72) Inventors: Michael Gilbert Banfield, Woodinville, WA (US); Alyssa Sue Branca, Woodinville, WA (US); Jillian Joiner, Woodinville, WA (US); John Harvey Borden, Burnaby (CA)

(73) Assignee: BanfieldBio Inc., Woodinville, WA (US)

(21) Appl. No.: 18/510,293

(22) Filed: Nov. 15, 2023

Related U.S. Application Data
(60) Provisional application No. 63/383,825, filed on Nov. 15, 2022.

(51) Int. Cl. A01N 43/40; A01M 25/00; A01N 25/00; A01N 25/10; A01N 63/30; A01P 7/02

(52) U.S. Cl. CPC A01N 43/40; A01M 25/002; A01N 25/002; A01N 25/10; A01N 63/30; A01P 7/02

(57) ABSTRACT

In a novel method and composition of heterodissemination technology, small mammals attracted to a food bait in a dissemination station acquire electrostatically charged acaricide laden microspheres that can he polymeric nano-porous microspheres loaded with one or more chemical acaricides, or calcium or sodium alginate microspheres that encapsulate an entomopathogen. Microspheres loaded with either type of acaricide kill ticks on the small mammals that acquire them, and when shed along small mammal pathways and in their dens, they also kill free-living ticks.

### FIELD OF THE INVENTION

This invention pertains to heterodissemination methods and compositions in which small mammals acquire and disperse acaricide-laden materials intended to kill ticks.

### BACKGROUND OF THE INVENTION

Autodissemination of pesticides is a technique distinct from traditional pesticide applications, which most commonly entail spraying a liquid formulation of a pesticide. The technique was developed primarily to deliver pesticides to target pests that are hard to reach by conventional methods of application. Characteristically autodissemination entails attracting mobile individuals of the target species to a source of a pesticide, acquisition of the pesticide by the attracted individuals, and transmission of that pesticide to conspecific individuals or to a habitat where the acquired and then shed pesticide has an adverse effect on conspecific individuals of any life stage occupying that habitat.

The primary focus of autodissemination has been on attracting mosquitoes to a source of liquid or dust laden with an insect growth regulator. The liquid or dust is then acquired externally by the attracted mosquitoes, is deposited in water when the mosquitoes oviposit, and in water the insect growth regulator controls the immature stages of both transmitter mosquitoes and others that oviposit in the same body of water (Caputo et. al. 2012; Unlu et al. 2017; Lwetoijera et al. 2019; Seixas et al. 2019). In a modification of this procedure, adult mosquitoes may be allowed to acquire an insecticide in the laboratory prior to release (Swale et al. 2017). In another modification male mosquitoes may acquire spores of a pathogenic fungus, which are then transmitted to females during mating (Scholte et al. 2004).

An example of autodissemination of a pesticide against another type of insect pest is attraction of male tobacco hornworms to pheromone-baited devices where they acquire particles of pathogenic virus, which in turn are transferred to females during mating and then to eggs laid by contaminated females (Jackson et al. 1992, 1994). A second example is attraction of male codling moths to pheromone-laden electrostatically charged dust particles (5-20μ diameter) which when acquired by male moths converts the male moths into mobile pheromone dispensers that can cause mating disruption, e.g., by inducing false trail following by uncontaminated males toward contaminated males instead of toward females (Howse et al. 2007).

A modification of autodissemination is heterodissemination, wherein members of one species are induced to acquire and disperse a pesticide intended to control members of another species. In one study, adult females of a species of midge were treated with oil or powder formulations of a mosquito larvicide, and when treated midges were released to oviposit in water, the shed larvicide caused substantial pupal mortality of mosquitoes co-infesting the same water (Wang et al. 2020). In another such study frogs were treated with a mosquito larvicide and when released they successfully transmitted the agent into bodies of water in which the larvicide successfully controlled larvae of two species of mosquitoes (Unlu et al. 2021).

In a third example, heterodissemination technology is directed against ticks (Acari: Ixodidae), which are of major public health and veterinary importance as ectoparasites and disease vectors (Heyman, et al. 2010; Rosenberg et al. 2018). Of the 18 pathogens ticks are known to transmit in time USA (Eisen and Paddock 2021), Borrelia burgdorferi, the principal causative agent of disease, is the most common. Lyme disease is the most reported vector-home disease in the US Armed Forces' list of Reportable Medical Events for 2010-2020 (O'Donnell et al. 2018, 2021), with rates as high as 860 cases per 100,000 person-years at military facilities in the northeastern USA (Hurt and Dorsey 2014). The Tick-Borne Disease Working Group's (2020) 2nd Report to Congress specifically recommends “disruption of tick biological processes contributing to pathogen transmission” to reduce incidence of Lyme and other tick-borne diseases. Country-wide, the incidence of Lyme disease has risen to an estimated 476,000 cases per year (Kugeler et al. 2021).

Small mammals like deer mice can be attracted to cylindrical “tick tubes” containing permethrin-treated cotton balls, which the animals collect as bedding material; when the bedding material is brought to the animals' dens, the permethrin is intended to kill ticks residing on the animals, as well as free living ticks in their dens (Eisen and Dolan 2016). Experimental results with this technology have been mixed, with only two of five field studies achieving the desired reduction in ticks residing on small mammals and most importantly reduction in numbers of ticks that have climbed vegetation searching (questing) for vertebrate hosts like humans to which they could attach. In an initial 1986-1987 trial in Massachusetts, tick tubes were dispersed in selected residential yards and not in others. In both years, the number of ticks on captured mice was greatly reduced in treated yards; moreover, the number of questing nymphs collected from vegetation was reduced almost 10-fold (Mather et al. 1987, 1988). Tick tubes were dispersed in a coastal Massachusetts site in the summer of 1987 and in spring and summer in 1988 and 1989; ticks on deer mice were virtually eliminated in all three years, and assessment of numbers of questing ticks in 1988 and 1989 revealed almost complete elimination of questing ticks on vegetation (Deblinger and Rimmer 1991). A 1988 study in New York found that spring treatment with tick tubes reduced both the numbers of ticks borne by deer mice and the numbers of ticks in the succeeding life stage in only one of two plots; summer treatment had no effect on tick populations at either plot in the following spring (Ginsberg 1992). In a subsequent study, a site in Connecticut was treated with tick tubes twice a year from 1989-1991. The numbers of ticks on captured deer mice were substantially reduced in all years, but in no case were the numbers of questing ticks on vegetation reduced, leading to the conclusion that treatment with tick tubes did not lower the risk of exposure to ticks infected with the Lyme disease pathogen (Stafford 1991, 1992). A similar study in New York State again found reduced infestation of deer mice by ticks in tick tube-treated areas, but no reduction in numbers of questing ticks (Daniels et al. 1991). Finally, in a California study, woodrats readily visited tick tubes and collected permethrin-impregnated cotton balls, but only 25% of woodrat nests contained collected cotton and the numbers of four species of woodrat-associated ticks were the same in treated and control areas (Leprince and Lane 1996). In addition to not all of the collected cotton being used to build nests, the lack of reduction in numbers of ticks that leave small mammal dens to quest for now hosts suggests that the pyrethroid ingredient in pesticide-laden cotton balls has insufficient longevity to control ticks that are resident in dens. Even though tick tubes have been commercialized their efficacy is questionable.

### BRIEF SUMMARY

A novel heterodissemination method and composition is described, wherein small mammals are drawn by a food bait to a dissemination station where they passively acquire electrostatically charged microspheres laden with an acaricide that can be a chemical or an encapsulated entomopathogen. A first chemical acaricide released from microspheres dislodged along small mammal trails and inside their dens rapidly kills free living ticks and a second slow-acting acaricide disrupts maturation and reproduction by later life stages. Ticks that contact encapsulated entomopathogen microspheres while residing on a small mammal or living free along their pathways or in their dens can be infected by the entomopathogen and die from die infection.

In some embodiments, the microspheres can be polymeric nano-porous microspheres (or shapes that approximate a spherical form) formulated with 0.5% of a charging agent commonly used in laser printer inks. Loading with chemical acaricides can be accomplished by incorporating an acaricide into the polymer itself, loading it into vacuoles within the microspheres, or coating the surface of the microspheres with it, respectively achieving slow, moderate or rapid release rates.

In some embodiments the microspheres can be entomopathogenic acaricides prepared using sodium or calcium alginate encapsulation and formulated with 0.5% of a charging agent commonly used in laser printer inks to produce electrostatically charged microspheres measuring 180 to 450μ containing 2 to 3% of an entomopathogen.

In some embodiments the longevity of polymeric microspheres loaded with chemical acaricides can be extended by loading them with two types of chemical acaricides, one in which the active ingredient is a fast-acting toxicant and/or repellent having an immediate effect on ticks on the small mammal and on free living ticks in their pathways and dens, and the other in which the active ingredient is a slow-acting growth regulator that inhibits growth, maturation and reproduction of ticks extending into the following generation.

In some embodiments, the electrostatically charged microspheres laden with either a chemical acaricide or an entomopathogenic acaricide can be placed in a dissemination station also holding a food bait that is attractive to small mammals that enter the dissemination station.

In some embodiments a dissemination station for microspheres can be a reusable secure bait box with entry/exit holes at each end and an internal chamber holding a small mammal food bait and acaricide-laden microspheres.

In some embodiments said entry/exit holes are wide enough to admit small mammals into the central chamber of the dissemination station but small enough to exclude larger animals.

In some embodiments, said small mammal food bait can be placed in the center of said internal chamber and the electrostatically charged acaricide-laden microspheres can be placed on the floor just inside the entry: exit holes so that small mammals attracted to the food bait must come into contact with and acquire the electrostatically charged microspheres on both entering and exiting the station.

In some embodiments the food bait can be sunflower seeds that contain substantial amounts of fatty acid necromones that are repellent to scavenger insects and other arthropods.

In some embodiments the electrostatically charged microspheres loaded with chemical acaricides or entomopathogenic acaricides can be acquired on the body surface of small mammals bearing an electric charge of the opposite polarity and can later he shed along their pathways and inside their dens.

While many embodiments utilize the present invention with small mammals, such as rats, squirrels, and chipmunks, other embodiments may involve distribution of microspheres on birds, reptiles, or terrestrial arthropods, depending on climate, habitat, and target. As described herein, mentions of small mammals could be substituted for other animals, or in some embodiments multiple different types of creatures may be targeted, such as embodiments targeting both birds and small mammals to distribute the microspheres.

### BRIEF DESCRIPTION OF THE DRAWINGS

Embodiments of the present invention are described in detail below with reference to the following drawings:

FIG. 1 shows a schematic depiction of a heterodissemination method for acquisition and dissemination of acaricides by small mammals. A small mammal (10), which may be infested with ticks (20) follows a path depicted by footprints (30), first entering a dissemination station (40) through an entry/exit port (60) that is large enough to admit a small mammal but too small in diameter to admit larger mammals (circle) in response to a food bait (80), where it acquires electrostatically charged polymeric nano-porous microspheres (50) loaded with one or more chemical acaricides or electrostatically charged sodium or calcium alginate encapsulated entomopathogenic acaricide microspheres with chemical or entomopathogenic acaricides. After exiting the dissemination station (40) through the entry/exit port (60) the small mammal (10) sheds microspheres (50) along its travel path (30) and also brings them into the underground den (70). Within the den resident ticks (20) contact shed acaricide-laden microspheres (50) and other small mammals may acquire acaricide-laden microspheres when they contact the carrier animal.

FIG. 2 shows a top view cross section of the interior of a bait box (40). Small mammals (10) enter by way of the entry/exit port (60) and must pass over the electrostatically charged polymeric nano-porous microspheres (50) loaded with chemical or entomopathogenic acaricides to reach the food bait (80).

FIG. 3 shows acquisition of polymeric nano-porous electrostatically charged microspheres (300) by a whitefooted deer mouse (302), Peromyscus leucopus, primarily (but not exclusively) on the tail (304), after walking on a surface on which the microspheres were dispersed. The photograph was taken under ultraviolet (UV) light causing the microspheres to glow because of a UV fluorescing dye incorporated into them.

### DETAILED DESCRIPTION

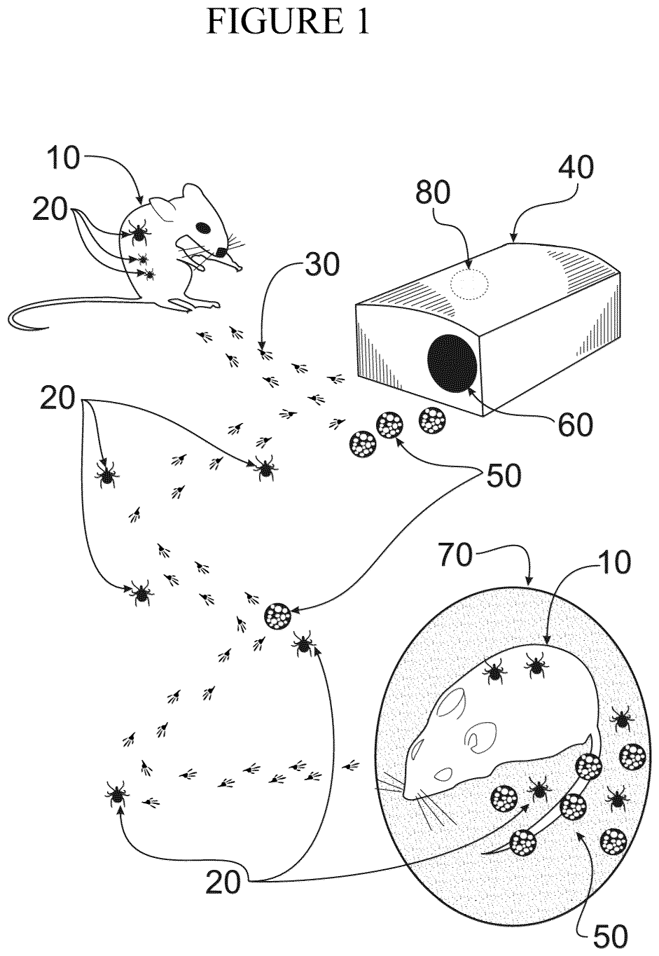

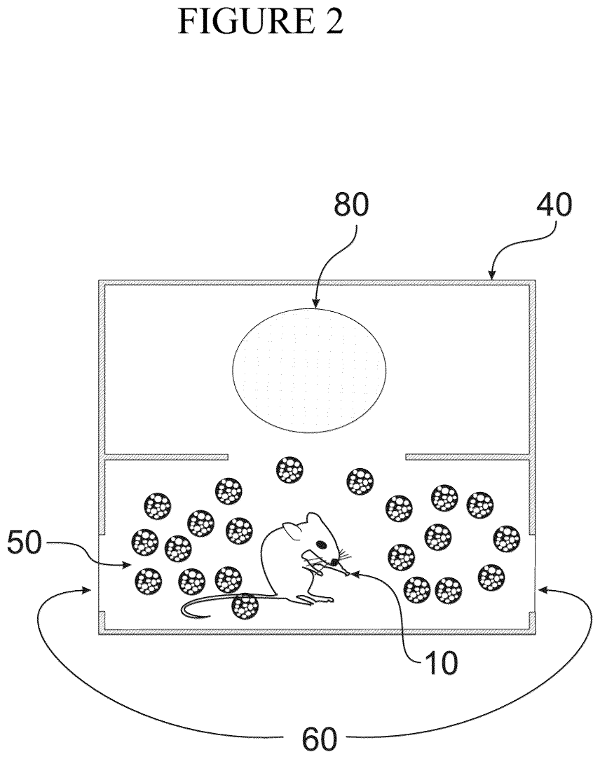

A novel heterodissemination method and composition for tick control is described (FIG. 1), in which small mammals are drawn by a food bait to a dissemination station where they passively acquire electrostatically charged microspheres laden with a chemical or entomopathogenic acaricide (FIG. 2) that kills ticks on the small mammals and are also dislodged along small mammal trails and in their dens where they kill free living ticks that have left a small mammal on which they have ridden and/or fed and/or the progeny of said ticks.

### Example 1

### Polymeric Nano-Porous Microspheres Laden With a Chemical Acaricide

Although electrostatically charged dusts have been used as a carrier for autodissemination of pesticides (Howse et al. 2007), the particles are characteristically flattened in the grinding manufacturing process and have a limited capacity for carrying a pesticide. Polymeric nano-porous microspheres were selected as one alternative, because they have a much greater loading capacity via three loading technologies for chemical pesticides: incorporating the pesticide active ingredient into the polymer during manufacturing, physically loading pesticide under vacuum into interior vacuoles of the microspheres, and surface coating. These technologies respectively provide slow, moderate, and rapid release rates; moreover, the pesticide load can constitute up to 85% of the weight of the formulated microsphere, much higher than for any other particulate pesticide.

Said microspheres can in part be loaded with fast-acting toxic and/or repellent chemical acaricides selected from the group including, but not limited to, permethrin, fipronil, spinosad, indoxacarb, nootkatone, 2-undecanone and 2-tridecanone. They can also be loaded with slow-acting growth regulators selected from the group including, but not limited to, fenoxycarb, pyriproxyfen, novaluron and methoprene. In a third iteration they can be loaded with a composition of a fast-acting chemical acaricide and a slow-acting chemical acaricide, providing for initial rapid mortality of ticks on a carrier animal, rapid mortality of free-living ticks along small mammal pathways and in their dens, and later providing for slow but effective disruption of growth, maturation and/or reproduction of subsequent life stages, extending into a second season of efficacy. In addition to providing long-lasting tick control, utilization of a dual chemical acaricide composition will minimize the risk of resistance build-up by utilizing multiple modes of action (Sparks and Nauen 2015).

Studies were conducted to evaluate various polymers, solvents, polymer/solvent combinations and active ingredient/polymer/solvent combinations. Solvents evaluated included dimethylformamide (DMF), ethyl ether, ethanol, methyl ethyl ketone, toluene, and others. Polymers evaluated included polysulfone, polyvinyl chloride, ethylcellulose, polylactic acid, a polyvinylchloride/styrene co-polymer, and others.

In an example process, polysulfone (UDEL P-3500 LCD MB7, Solvay Specialty Polymers, Alpharetta, GA) was added with low stirring at 7.97% (w/w) to DMF that had been warmed to 60° C. The solution included an ultraviolet fluorescing pigment and 0.5% of a charging agent commonly used in laser printer inks. After covering, the mixture was heated to 60° C. with stirring at ˜450 rpm for 4 h, until the polymer was completely dissolved. The final solution showed a viscosity of about 30 Centipoise at 29° C. The heated polymer solution was filtered through a 100μ stainless steel screen and then placed into a pressure vessel. The polymer solution was pumped from the pressure vessel using 0103.4 kPa air pressure through an air atomizing nozzle assembly model 1/8J+SUE-15B (SprayingSystems Inc., Glendale Heights, IL) using 137.9 kPa shear air pressure. The polymeric nano-porous microparticles were collected in an agitated water bath set approximately 20 cm below the nozzle assembly. The water bath was formulated with 13% to 18% DMF and 0.1% Triton X-100 (Dow, Midland, MI), a secondary alcohol ethoxylate, nonionic surfactant. Upon completion of the spraying process, the water bath/microsphere mixture was pumped through a series of stainless steel filters and wet separated into various size ranges and dried at 95° C. with sustained air flow for about 24 h. Dried microspheres were then lightly milled and dry separated using a vibrating sieve machine and separated to obtain microspheres that were between 180 and 450μ, the intended particle size expected to be optimal tier mammal-borne materials.

Dried microspheres were quantitatively added to a solution of active ingredient chemical acaricide, calculated to contain enough active ingredient mass to provide a specific loading rate in the microspheres. For example, 1.5 g of dried polysulfone beads were added to a solution containing 8.5 g of pyriproxyfen in 17 g of ethyl ether. The vessel containing the resulting mixture was placed into a vacuum chamber, where vacuum to 84.7 kPa or more was cycled three times, or until no more air was evacuated from the microspheres. This process loaded the microspheres, which were subsequently filtered and washed with a small amount of excess ethyl ether, and then air dried. The resulting product was a free-flowing composition comprised of polymeric nano-porous microspheres containing 80% to 85% active ingredient.

### Example 2

### Entomopathogen-Laden Microspheres

Entomopathogenic organisms, such as Metarhizium anisopliae or Beauveria bassiana (fungi that kill insects and ticks) are commonly used as pesticides. Dispersed fungal spores germinate after contact with the cuticle, and the resulting hyphae invade and kill the insect or tick (Harith-Fadzilah et al. 2021). Entomopathogen formulations are normally directly applied directly onto the target insect or tick or, for non-blood-feeding insects, onto or incorporated into a food substrate.

For formulation within microspheres, entomopathogen spores are prepared using a typical sodium or calcium alginate encapsulation such as that of Meirelles (2023), wherein a 2% solution is homogenized with a conidial suspension and then dripped into a calcium chloride solution with stirring to form encapsulated M. anisopliae microspheres. This method is typically used to prolong the storage and field life and to provide thermal stability and UV protection to the final product. The process results in particles that are 500 to 900μ in diameter that are typically deployed as an emulsifiable concentrate solution.

For heterodissemination application, instead of simply dripping the sodium or calcium alginate encapsulate conidial suspension into a calcium chloride condensing bath, the encapsulate is combined with 0.5% of a charging agent commonly used in laser printer inks and delivered under pressure (7 to 15 psi) or by use of spinning disk atomization which creates particles of target diameters (180 to 450μ in diameter) based upon the rotational speed of the disk to which the encapsulate is delivered. The encapsulate is then air dried under controlled temperature and humidity conditions to form a dry powder. The filial product contains 2 to 3% entomopathogen spores. Depending on the needs of a given embodiment, the exact pressures and target diameters might vary.

### Example 3

### Acquisition of Microspheres by a Heterodissemination Mammal

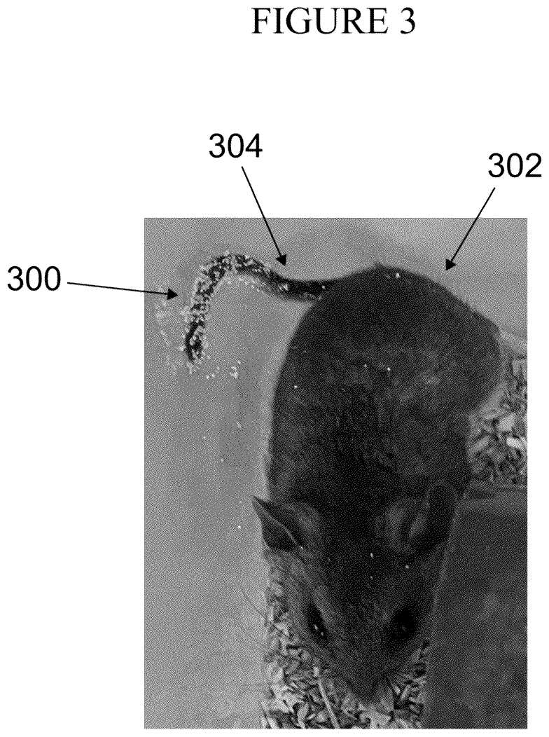

Microspheres produced by the method of Example 1 were loaded to 80% with methylated seed oil to evaluate acquisition of microspheres by white noted deer mice, Peromyscus leucopus, in the laboratory. Thirty-live mg of final product was placed in a Petri dish in a rodent enclosure, whereupon the rodents acquired the particles. It was expected that the microspheres might act like known rodent powder formulations, which commonly attach and coat the underside fur and lower extremities of mice. Alternatively, since the microspheres contained a charging agent causing, them to act as an electret, it was proposed that the particles would spread over the fur, in the same manner as electrostatically charged Styrofoam particles attach to mammals. Surprisingly, neither outcome occurred. The charged microspheres preferentially attached to the rodent's tail, with only a few particles attached to the fur (FIG. 3). These particles remained attached to the mice until they were dislodged by contact with a substrate or were groomed off.

### Example 4

### Dissemination Station

Many species of ticks are ectoparasites of small mammals during an early part of their life cycle before they leave the small mammals and their dens to quest for larger vertebrate hosts like deer and humans (Halsey et al. 2018; Tsao et al. 2021). Reduction of the population level of the stages associated with small mammals should thus reduce the risk of later stages transmitting tick-borne disease to humans. However, ticks in cryptic habitats like small mammal pathways and dens are almost impossible to kill with acaricidal sprays (Eisen and Dolan 2016). Moreover, landscape level reduction of small mammal populations is logistically improbable and environmentally unacceptable. Employing small mammals in a heterodissemination tactic to deliver acaricides to ticks by proxy presents a solution to the above problems. A cost-effective dissemination station in which small mammals can acquire an acaricide is beneficial for the heterodissemination tactic to provide the desired reduction in small mammal associated tick populations.

A dissemination station can be reusable or biodegradable and disposable. A reusable station can he a waterproof commercial mouse bait box, or facsimile thereof, with entrance holes that admit small mammals and exclude larger mammals, a runway, and a location where a food bait can be placed. A built-in locking mechanism prevents opening by anyone but a designated user and makes the device suitable for use in and around residences where humans or companion animals could come in contact with it.

A disposable station. can have similar features, excluding the locking mechanism, and can be made from a biodegradable substance such as cellulose coated with a biodegradable wax to provide temporary protection from water damage. Disposable stations are well suited for use in locations not frequented by humans or companion animals. In one embodiment, a disposable dissemination station can be made of a single piece of cardboard that is folded into a rectangular box with precut entrance/exit holes at each end.

For both reusable and disposable heterodissemination stations, a food bait can be placed at or near the center point of the floor and electrostatically charged acaricide-laden microspheres can be placed on the floor just inside the entrance/exit holes, so that a small mammal unavoidably contacts and acquires the microspheres on its fur or skin while moving toward the food bait and while exiting the station.

In another embodiment, intrusion, and consumption by scavenging insects such as ants or cockroaches and other arthropods such as sowbugs can be avoided by using sunflower seeds that are rich in oleic and linoleic acid, which can be perceived as repellent necromones and avoided by scavengers (Wilson et al. 1968; Rollo et al. 1994).

Depending on the embodiment, the dissemination station, whether reusable, disposable, or partially both, might be comprised of a variety of components and pieces, with numbers of entrances, types of baits, and placement of components, baits and microspheres varying between each.

### Example 5

### Field Acquisition and Heterodissemination of Microspheres

Polymeric microspheres were produced by the method of Example 1 using PVC GEON 137 (Orbia, Mexico City, MX) loaded with 70% polyethylene glycol (PEG) 8000 (Dow, Midland MI). The PEG 8000 microspheres were screened to a size range of 180-450μ. PEG 8000 was used as an inert proxy for various active ingredient materials, so that field testing could be conducted without active pesticides. One g of the heterodissemination formula was placed in the internal walkway of a standard mouse rodent bait station made of plastic with two entrance holes and an internal bait reservoir. A 5-g “puck” of parawax and black sunflower seeds was placed within the bait reservoir. Treated stations were placed in areas where feral whitefooted deer mice were present. Untreated, baited stations were placed 1-20 m from the treated stations. Untreated stations were evaluated every 24 h for 4 days. Using a UV lamp, the heterodissemination particles were found to be lightly distributed in trails extending tens of centimeters from the treated stations, absent for most of the distance between treated and untreated stations, but present in untreated stations up to 13 m away from the treated stations, thus demonstrating successful heterodissemination. Field observations also showed small numbers of microspheres accumulating at habitual grooming locations, around rodent den entrances, and within the rodent dens.

While a number of exemplary aspects and embodiments have been discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope.

The foregoing examples should be viewed as demonstrations of potential embodiments and are not exhaustive or necessarily conclusive as to the effectiveness of the present invention. In many situations, it may be preferable to utilize mixtures and conditions different from the above or use an embodiment of the invention which an example may have indicated was less effective but may be more optimal in such situation.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words “comprise”, “comprising”, and the like are to he construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application. Many changes, modifications, variations and other uses and applications of the present construction will, however, become apparent to those skilled in the art after considering the specification and the accompanying figures. All such changes, modifications, variations and other uses and applications which do not depart from the spirit and scope of the invention are deemed to be covered by the invention which is limited only by the claims which follow.

It should be understood that while certain preferred forms, embodiments, and examples of this invention have been illustrated and described, the present invention is not to be limited to the specific forms or arrangement of parts described and shown, and that the various features described may he combined in other ways than those specifically described without departing from the scope of the present invention.

### REFERENCES CITED

### U.S. Patent Documents

Jackson, D. M, G. Brown and G. L. Nordin. 1994. Method and apparatus for autodissemination of insect pathogens. U.S. Pat. No. 5,359,807.

### Other Publications

Caputo, B, A. Lenco, D. Cianci, M. Pombi, V. Petarca, A. Baseggio, G. J. Devine and Alessandra della Torre. 2012. The “auto-dissemination” approach: A novel concept to fight Aedes albopictus in urban areas. PLoS Neglected Tropical Diseases 6(8): e1793.
Daniels, T. J., D. Fish and R. C. Falco. 1991. Evaluation of host-targeted acaricide for reducing risk of Lyme disease in southern New York State. Journal of Medical Entomology 28: 537-543.
Deblinger, R. D. and D. W. Rimmer. 1991. Efficacy of a permethrin-based acaricide to reduce the abundance of Ixodes dammini (Acari Ixodidae). Journal of Medical Entomology 28: 708-711.
Eisen, L. and M. C. Dolan. 2016. Evidence for personal protective measures to reduce human contact with blacklegged ticks and for environmentally based control methods to suppress host-seeking blacklegged ticks and reduce infection with Lyme disease spirochetes in tick vectors and rodent reservoirs. Journal of Medical Entomology 53: 1063-1092
Eisen, R. J. and C. D. Paddock. 2021. Tick and tickborne pathogen surveillance as a public health tool in the United States. Journal of Medical Entomology 58: 1490-1502.
Ginsberg, H. S. 1992. Ecology and management of ticks and Lyme disease at Fire island National Seashore and selected eastern national parks. Scientific Monograph NPS/NRSUNJ/NRSM-92/20. US Department of the Interior, National Parks Service.
Halsey, S. J., B. Allan and J. Miller. 2018. The role of Ixodes scapularis, Borrelia burgdorferi and wildlife hosts in Lyme disease prevalence: a quantitative review. Ticks and Tick-Borne Diseases 9: 1103-1114.
Harith-Fadzilah, N., I. Abd Ghani and M. Hassan. 2021. Omics-based approach in characterizing mechanisms of entomopathogenic fungi pathogenicity: a case example of Beauveria bassiana. Journal of King Saud University—Science (33)2:101332.
Heyman, P., C. Cochez, A. Hofhuis, J. van der Giessen, H. Sprong, S. R. Porter, B. Losson, C. Saegerman, O. Donoso-Mantke, M. Niedrig, and A. Papa. 2010. A clear and present danger: Tick-borne diseases in Europe. Expert Review of Anti-infective Therapy 8: 33-50.
Howse, P., C. Armsworth and I. Baxter. 2007. Autodissemination of semiochemicals and pesticides: a new concept compatible with the sterile insect technique. Pp. 275-281. In: M. J. B. Vreysen, A. S. Robinson and J. Hendrichs. (Eds.). (Area-wide control of insect pests. From research to field implementation. Springer, Dordrecht, The Netherlands.
Hurt, L. and K. A. Dorsey. 2014. The geographic distribution of incident Lyme disease among active component service members stationed in the continental United States, 2004-2013. Medical Surveillance Monthly Report 21 (5): 13-15.
Jackson, D. M., G. C. Brown, G. L. Nordin and D. W. Johnson. 1992. Autodissemination of a baculovirus for management of tobacco budworms (Lepidoptera: Noctuidae) on tobacco. Journal of Economic Entomology 85: 710-719.
Kugeler, K. J., A. M. Schwartz, M. J. Delorey, P. S. Mead and A. F. Hinckley, 2021. Estimating the frequency of Lyme disease diagnoses, United States, 2010-2018. Emerging Infections Diseases 27: 616-619.
Leprince, D. J. and R. S. Lane, 1996. Evaluation of permethrin-impregnated cotton balls as potential nesting material to control ectoparasites of woodrats in California. Journal of Medical Entomology 33: 355-360.
Lwetoijera, D., S. Kiware, F. Okumu, G. J. Devine and S. Majambere. 2019. Autodissemination of pyriproxyfen suppresses stable populations of Anopheles arabiensis under semi-controlled settings. Malaria Journal (2019) 18:166.
Mather, T. N., J. M. C. Ribeiro and A. Spielman. 1987. Lyme disease and babesiosis: acaricide focused on potentially infected ticks. American Journal of Tropical Medicine and Hygiene 36: 609-614.
Mather, T. N., J. M. C. Ribeiro, S. I. Moore and A. Spielman. 1988. Reducing transmission of Lyme disease spirochetes in a suburban setting. Annals of the New York Academy of Sciences 539: 402-403.
Nobrega Meirelles, L., E. Mesquita, T. Almeida Corrêa, R. de Oliveira Barbosa Bitencourt, J. L. Oliveira, L. Fernandes Fraceto, M. Guedes Camargo and V. R. E. Pinheiro Bittencourt. 2023. Encapsulation of entomopathogenic fungal conidia: evaluation of stability and control potential of Rhipicephalus microplus. Ticks and Tick-borne Diseases 14(4):102184.
O'Donnell, F. L., S. Stahlman and M. Fan. 2018. Surveillance for vector-borne diseases among active and reserve component service members, U.S. Armed Forces, 2010-2016. Medical Surveillance Monthly Report 25 (2): 8-15.
O'Donnell, F. L., M. Fan and S. Stahlman. 2021. Surveillance for vector-borne diseases among active and reserve component service members, U.S. Armed Forces, 2016-2020. Medical Surveillance Monthly Report 28 (2): 11-15.
Rollo, C. D., E. Czyzewska and J. H. Borden. 1994. Fatty acid necromones for cockroaches. Natumissenschaften 81: 409-410.
Rosenberg, R., N. P. Lindsey, M. Fischer, C. J. Gregory, A. F. Hinckley, P. S. Mead, G. Paz-Bailey, S. H. Waterman, N. A. Drexler, G. J. Kersh, H. Hooks, S. K. Partridge, S. N. Visser, C. B. Beard and L. R. Petersen. 2018. Vital signs: Trends in reported vectorborne disease cases—United States and Territories, 2004-2016. Morbidity and Mortality Weekly Report 67: 496-501.
Seixas, G., R. E. L. Paul, B. Pires, G. Alves, A. de Juses, A.-C. Silva, G. J. Devine and C. A. Sousa. 2019. An evaluation of efficacy of the auto-dissemination technique as a tool for Aedes aegypti control in Madeira, Portugal. Parasites and Vectors (2019) 12:202.
Scholto, E.-J., B. G. Knols and W. Takken. 2004. Autodissemination of the entomopathogenic fungus Metarhizium anisopliae amongst adults of the malaria vector Anopheles gambiae. Malaria Journal 2004, 3:45 doi:10.1186/1475-2875-3-45.
Sparks, T. C. and R. Nauen. 2015. IRAC: Mode of action classification and insecticide resistance management. Pesticide Biochemistry and Physiology 121: 122-128.
Stafford, K. C., III. 1991. Effectiveness of host-targeted permethrin in the control of Ixodes dammini (Acari: Ixodidae). Journal of Medical Entomology 28: 611-617.
Stafford, K. C., III. 1992. Third-year evaluation of host-targeted permethrin for the control of Ixodes dammini (Acari: Ixodidae) in southeastern Connecticut. Journal of Medical Entomology 79: 717-720.
Swale, D. R., Z. Li, J. Z. Kraft, K. Healy, M. Liu. C. M. David, Z. Liu and L. D. Foil. 2018. Development of an autodissemination strategy for the deployment of novel control agents targeting the common malaria mosquito. Anopheles quadrimaculatus Say (Diptera: Culicidae). PLoS Neglected Tropical Diseases 12(4): e0006259.
Tick-Borne Disease Working Group. 2020. 2020 Report to Congress. Washington, DC: US Department of Health and Human Services.
Tsao, J., S. A. Hamer, S. Han, J. L. Sidge and G. J. Hickling. The contribution of wildlife hosts to the rise of ticks and tick-borne diseases in North America. Journal of Medical Entomology 58: 1565-1587.
Unlu, I., D. S. Suman, K. Klingler, A. Faraji and R. Gaugler. 2017. Effectiveness of autodissemination stations containing pyriproxyfen in reducing immature Aedes albopictus populations. Parasites and Vectors (2017) 10:139.
Unlu, I., A. Faraji, Y. Wang, I. Rochlin and R. Gaugler. 2021. Heterodissemination: precision insecticide delivery to mosquito larval habitats by cohabiting vertebrates. Scientific Reports (2021) 11: 14119.
Wang, Y., D. S. Suman, K. Chandel, G. M. Williams, I. Unlu and R. Gaugler. 2020. Heterodissemination: precision targeting container Aedes mosquitoes with a cohabiting midge species carrying insect growth regulator. Pest Management Science 76: 2105-2112.
Wilson, E. O., N. I. Durlach and L. M. Roth. 1958. Chemical releasers of necrophoric behavior in ants. Psyche 65: 108-114.

What is claimed is:

1. A method of formulation and heterodissemination of acaricides, the method comprising the steps of:
selecting at least one microsphere disseminator from the list comprising:
microspheres of encapsulated entomopathogenic acaricides; or
polymeric, nano-porous microspheres configured to be loaded with chemical acaricides;
electrostatically charging the microspheres enabling them to be passively acquired by small mammals bearing an electric charge of the opposite polarity;
utilization of dissemination stations with entry/exit ports of a diameter that admits small mammals into an internal chamber, but excludes larger mammals;
loading said dissemination stations with a food bait that is attractive to small mammals and entices them to enter the dissemination station;
further loading said dissemination stations with said electrostatically charged acaricide-laden microspheres;
acquisition electrostatically of said acaricide-laden microspheres by small mammals inside the dissemination station;
dissemination outside of at least one dissemination station by small mammals of acquired electrostatically charged acaricide-laden microspheres by depositing them along small mammal pathways and inside their dens.

2. The methods of claim 1, wherein at least one acaricides controls or mitigates ticks in the Order Acari, Family Ixodidae or Family Argasidae

3. The method of claim 1, further comprising at least one of the following steps:
loading chemical acaricides into the polymer during the manufacturing process of the microspheres, providing slow release of active ingredients by diffusion to the surface of the solid polymer;
loading chemical acaricides into vacuoles within the microspheres after manufacture, providing a moderate release rate of active ingredients as they pass through pores leading to the surface of the microspheres; or
loading chemical acaricides onto the surface of microspheres, providing a rapid release mechanism, or
loaded into and onto microspheres by all three methods, enabling all three release mechanisms from each microsphere.

4. The method of claim 1, wherein at least one chemical acaricide is a fast-acting toxicant and/or repellent selected from the group including permethrin, fipronil, spinosad, indoxacarb, nootkatone, 2-undecanone and 2-tridecanone

5. The method of claim 1, wherein at least one chemical acaricide is a growth regulator selected from the group including fenoxycarb, pyriproxyfen, novaluron and methoprene

6. The method of claims 1, 4 and 5, wherein the fast-acting toxicant and/or repellent kills and/or repels ticks with substantially immediate effect, and the slow-acting growth regulator disrupts growth, maturation and/or reproductive development of ticks extending into the season after deposition along small mammal pathways or within their dens

7. The method of claim 1 wherein the microspheres comprising encapsulated entomopathogens using calcium or sodium alginate, may be produced by a complex coacervation, thermal gelation, ionic gelation, spray-drying, coacervation, or LentiKats® immobilization and the encapsulate material may be synthetic polymers like polyurethane, polyacrylate, and polyvinyl alcohol, or natural polymers like alginate, starch, cellulose, and gelatin

8. The method of claim 1 where the encapsulated entomopathogens may be selected from the groups including spore-forming bacterial entomopathogens such as Bacillus spp., Paenibacillus spp., and Clostridium spp., non-spore-forming bacteria such as Pseudomonas spp., Serratia spp., Yersinia ssp., Photorhabdus spp., Xenorhabdus spp., Acinetobacter spp., or Streptomyces spp., or fungi such as Beauveria spp., Hirsutella spp., Lecanicillium spp., or Metarhizium spp.

9. The method of claim 1, wherein the dissemination station is either a secure plastic small mammal bait box or a secure metal small mammal bait box

10. The method of claim 1, wherein the food bait is comprised of sunflower seeds that are attractive to small mammals but not to ants, cockroaches, and other invertebrate competitors because the seeds contain repellent fatty acid necromones

11. A device comprising a small mammal dissemination station configured to contain a food bait and electrostatically charged microspheres wherein the microspheres are comprised of at least one of: polymeric nano-porous microspheres loaded with at least one chemical acaricide; or microspheres encapsulated with entomopathogenic acaricide.

12. The device of claim 11, wherein the dissemination station is configured to admit small mammals into an internal chamber but excludes larger mammals.

13. The device of claim 11, wherein the dissemination station is comprised of plastic or metal and is reusable.

14. The device of claim 11, wherein the dissemination station is comprised of a material that is biodegradable.

15. The device of claim 11, wherein the food bait is comprised of sunflower seeds.

16. The device of claim 11, wherein the electrostatically charged acaricide-laden microspheres are acquired by one or more small mammals that enter the dissemination station.

17. The device of claim 11, wherein the electrostatically charged acaricide-laden microspheres acquired by one or more small mammals are deposited outside of the dissemination station along small mammal pathways and inside their dens.
